(19) United States
(12) Patent Application Publication
(10) Pub. No.: US 2026/0177884 A1
(43) Pub. Date: Jun. 25, 2026

(54) IMAGING MODULE HAVING COLOR WHEEL

(71) Applicant: GUANGZHOU LUXVISIONS INNOVATION TECHNOLOGY LIMITED, Guangzhou City (CN)

(72) Inventors: Shih-Chieh Yen, Guangzhou City (CN); Sheng-Chieh Yang, Guangzhou City (CN)

(73) Assignee: GUANGZHOU LUXVISIONS INNOVATION TECHNOLOGY LIMITED, Guangzhou City (CN)

(21) Appl. No.: 19/296,911

(22) Filed: Aug. 11, 2025

(30) Foreign Application Priority Data
Dec. 19, 2024 (CN) 202411883683.X

(51) Int. Cl. G03B 11/00; G02B 26/00

(52) U.S. Cl. CPC G03B 11/00; G02B 26/008

(57) ABSTRACT

An imaging module having a color wheel is provided. The imaging module includes an image sensor, a lens group, a color wheel, a light-shielding sheet, a light-shielding blade, and a driving element. The lens group is disposed above the image sensor. The color wheel is disposed above the lens group and includes a plurality of filters of different filtering wavelength bands. The light-shielding sheet is disposed above the color wheel and has a notch, wherein the notch exposes a part of the plurality of filters. The light-shielding blade is connected to the light-shielding sheet and is configured to move relative to the notch so as to cover the notch to different degrees. The driving element is configured to drive at least one of the color wheel and the light-shielding sheet to rotate.

### CROSS-REFERENCE TO RELATED APPLICATION

This application claims the priority benefit of China application serial no. CN 202411883683.X, filed on Dec. 19, 2024. The entirety of the above-mentioned patent application is hereby incorporated by reference herein and made a part of this specification.

### BACKGROUND

### Technical Field

The disclosure relates to an imaging module, and more particularly to an imaging module having a color wheel.

### Description of Related Art

A color wheel was originally a key component in digital light processing (DLP) technology and is responsible for separating white light from a light source into basic colors such as red, green, and blue to generate a color image. This technology is widely applied in commercial, educational, and home theater projectors due to its ability to provide excellent color reproduction and brightness.

The color wheel is composed of a transparent disk divided into multiple sector areas, each area covered with a filter of a different color. Common configurations include red, green, and blue. When the projector operates, the color wheel rotates at high speed, allowing the white light to pass through these filters in sequence, thereby separating the light into monochromatic light.

The monochromatic light is sequentially projected onto a digital micro-mirror device (DMD) chip. The DMD chip contains millions of tiny mirrors, each corresponding to one pixel in the image. After the light passes through the color wheel, the DMD chip adjusts the tilt angle of the mirrors based on the color of the light to determine whether the light is reflected into the projection lens. The DMD chip can precisely control the brightness and color of each pixel to ultimately synthesize a complete color image.

The main advantage of the color wheel is its cost-effectiveness and efficiency in color projection. Compared to multi-chip DLP projectors, single-chip DLP projectors require just one DMD chip and a color wheel to generate a color image, significantly reducing manufacturing cost. Meanwhile, optimized design of the color wheel can improve color accuracy and saturation to provide a better viewing experience.

However, there is currently no technology that applies a color wheel to a camera module. Therefore, the color saturation achievable by current camera modules remains to be improved, and the cost of current camera modules is difficult to further reduce. In addition, there is also no current technology that applies a variable aperture suitable for a color wheel to a camera module.

### SUMMARY

The disclosure relates to an imaging module having a color wheel, which can achieve higher color saturation and can achieve dual optimization of color and contrast, or can have lower cost.

An embodiment of the disclosure provides an imaging module having a color wheel. The imaging module includes an image sensor, a lens group, a color wheel, a light-shielding sheet, a light-shielding blade, and a driving element. The lens group is disposed above the image sensor. The color wheel is disposed above the lens group and includes a plurality of filters of a different filtering wavelength band. The light-shielding sheet is disposed above the color wheel and has a notch. The notch exposes a part of the plurality of filters. The light-shielding blade is connected to the light-shielding sheet and is configured to move relative to the notch so as to cover the notch to a different degree. The driving element is configured to drive at least one of the color wheel and the light-shielding sheet to rotate.

In the imaging module having the color wheel in the embodiment of the disclosure, the color wheel disposed above the lens group is adopted. The color wheel includes a plurality of filters of a different filtering wavelength band. The light-shielding sheet disposed above the color wheel is adopted. The light-shielding sheet has the notch to expose a part of the plurality of filters. By driving at least one of the color wheel and the light-shielding sheet to rotate, images of light of different wavelength bands can be sequentially sensed by the image sensor. The images of the light of different wavelength bands can be synthesized into a color image. Therefore, a color image with higher color saturation can be further sensed by the image sensor. In addition, in the imaging module having the color wheel in the embodiment of the disclosure, since the color wheel is adopted to sequentially filter out light of different wavelength bands, a structurally simpler image sensor can be used. Thus, a cost of the imaging module can be effectively reduced. Furthermore, in the imaging module having the color wheel in the embodiment of the disclosure, the light-shielding blade connected to the light-shielding sheet is adopted. The light-shielding blade is configured to move relative to the notch so as to cover the notch to a different degree. As a result, dual optimization of color and contrast is achieved.

### BRIEF DESCRIPTION OF THE DRAWINGS

FIG. 1A is a perspective schematic view of an imaging module having a color wheel according to an embodiment of the disclosure.

FIG. 1B is a cross-sectional schematic view of the imaging module having a color wheel of FIG. 1A cut along an optical axis.

FIG. 2A is a schematic view from an oblique angle of an upper side of a light-shielding blade, a light-shielding sheet, and a color wheel in FIG. 1A.

FIG. 2B is a schematic view from an oblique angle of the upper side of the color wheel in FIG. 1A.

FIG. 3A and FIG. 3B are top schematic views of the light-shielding blade, the light-shielding sheet, the color wheel, the coil, the magnet, and the connecting cord in FIG. 1A in two shielding states of the light-shielding blade.

FIG. 4A is a perspective schematic view from an oblique angle of a lower side of a first magnet, a first coil, an annular circuit board, and the color wheel in the imaging module having the color wheel of FIG. 1A.

FIG. 4B is a perspective schematic view from an oblique angle of an upper side of a first coil, an annular circuit board, a second magnet, a second coil, the light-shielding sheet, and the color wheel in the imaging module having the color wheel of FIG. 1A.

FIG. 5A and FIG. 5B are partial perspective schematic views from an oblique angle of an upper side of the light-shielding blade, the light-shielding sheet, the color wheel, the coil, the magnet, and the connecting cord in FIG. 1A in two shielding states of the light-shielding blade.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

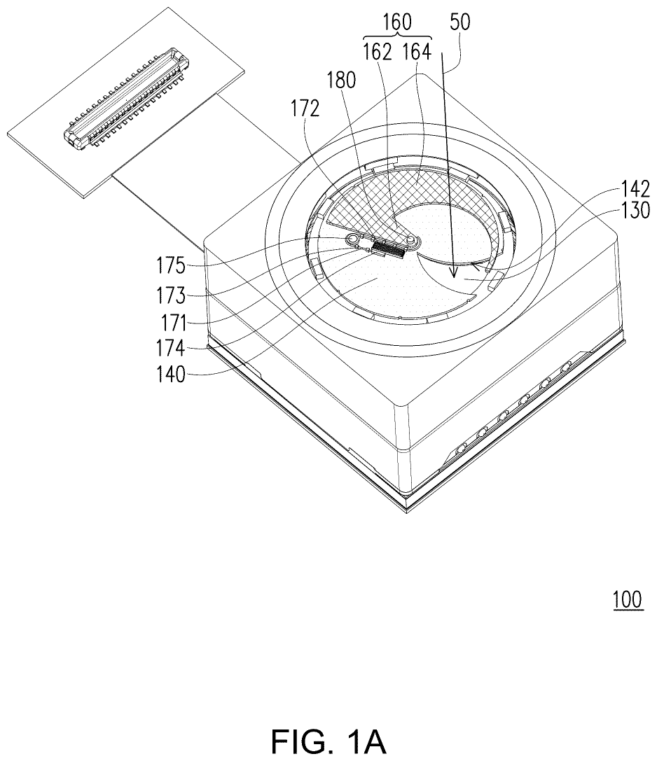

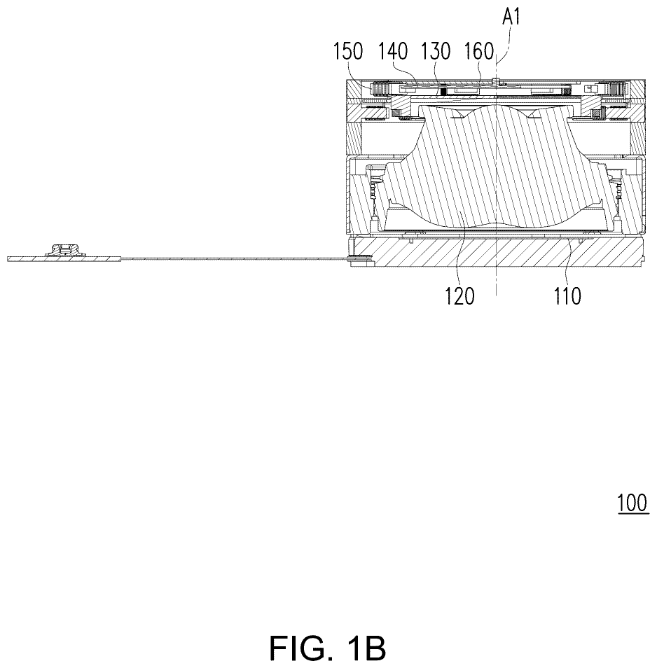

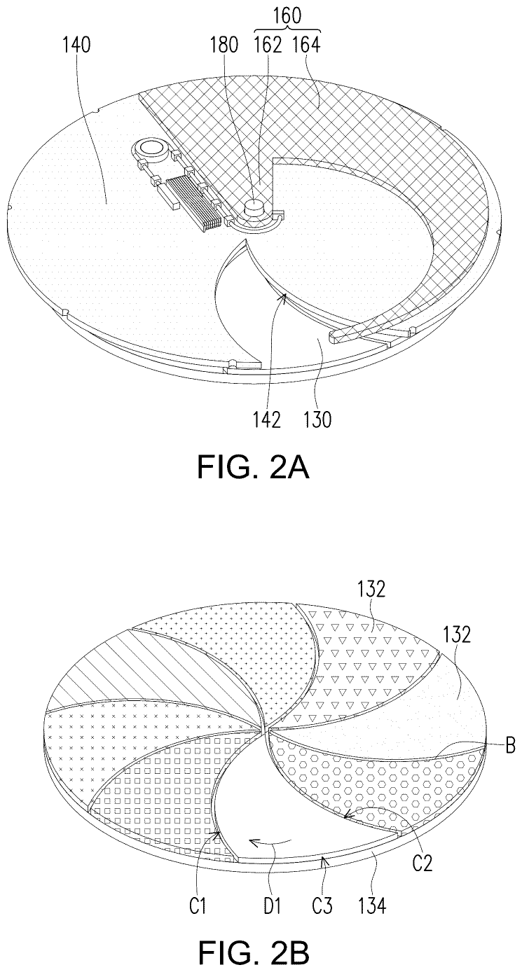

FIG. 1A is a perspective schematic view of an imaging module having a color wheel according to an embodiment of the disclosure. FIG. 1B is a cross-sectional schematic view of the imaging module having a color wheel of FIG. 1A cut along an optical axis. FIG. 2A is a schematic view from an oblique angle of an upper side of a light-shielding blade, a light-shielding sheet, and a color wheel in FIG. 1A. FIG. 2B is a schematic view from an oblique angle of an upper side of the color wheel in FIG. 1A. Referring to FIG. 1A, FIG. 1B, FIG. 2A, and FIG. 2B, an imaging module 100 having a color wheel in this embodiment includes an image sensor 110, a lens group 120, a color wheel 130, a light-shielding sheet 140, a light-shielding blade 160, and a driving element 150. The lens group 120 is disposed above the image sensor 110. The lens group 120 may include at least one lens, configured to image an external object onto the image sensor 110. The color wheel 130 is disposed above the lens group 120 and includes a plurality of filters 132 of different filtering wavelength bands (as shown in FIG. 2B). The light-shielding sheet 140 is disposed above the color wheel 130 and has a notch 142, wherein the notch 142 exposes a part of the filters 132.

The driving element 150 is configured to drive at least one of the color wheel 130 and the light-shielding sheet 140 to rotate. In this embodiment, a shape of the notch 142 corresponds to a shape of the filters 132, and when the driving element 150 drives at least one of the color wheel 130 and the light-shielding sheet 140 to rotate, the notch 142 sequentially exposes the filters 132. In this embodiment, the filters 132 of different filtering wavelength bands include a red filter, a green filter, and a blue filter. In an embodiment, the filters 132 of different filtering wavelength bands may include at least one of an infrared transmitting filter and an ultraviolet transmitting filter. Or, in an embodiment, the filters 132 of different filtering wavelength bands may include at least one of a purple filter, a yellow filter, and an orange filter. In FIG. 2B, the filters 132 of the color wheel 130 are eight types of filters including a red filter, a green filter, a blue filter, a purple filter, a yellow filter, an orange filter, an infrared transmitting filter, and an ultraviolet transmitting filter. In addition, in this embodiment, the filters 132 are annularly arranged around an optical axis A1 of the lens group 120. Further, in this embodiment, the filters 132 may be attached to a substrate 134, and the substrate 134 is, for example, a white glass plate and is, for example, a circular plate.

A light 50 from an external object passes through the notch 142 of the light-shielding sheet 140, and then is filtered by the filters 132 of the color wheel 130 into light of a specific wavelength band, and then the light filtered into the specific wavelength band is converged by the lens group 120 to the image sensor 110, and then is imaged on the image sensor 110. When the driving element 150 drives at least one of the color wheel 130 and the light-shielding sheet 140 to rotate, the notch 142 of the light-shielding sheet 140 sequentially exposes the filters 132 of different filtering wavelength bands, so that light of different wavelength bands is sequentially imaged on the image sensor 110. By recording timing of the color wheel 130, a controller electrically connected to the image sensor 110 and configured to process signals of the image sensor 110 is able to analyze which wavelength band of image is sensed by the image sensor 110 at which time, and thus information of a color image synthesized from the images of the different wavelength bands can be obtained.

In an embodiment, the driving element 150 is configured to drive the color wheel 130 to rotate in a stationary state of the light-shielding sheet 140, or is configured to drive the light-shielding sheet 140 to rotate in a stationary state of the color wheel 130. This way, the notch 142 of the light-shielding sheet 140 is able to sequentially expose the filters 132 of different filtering wavelength bands. In this embodiment, the driving element 150 may be configured to drive the color wheel 130 to rotate in the stationary state of the light-shielding sheet 140, and to drive the light-shielding sheet 140 to rotate in the stationary state of the color wheel 130, so that when the notch 142 moves to rotate relative to the lens group 120 to different angles, the images of the different wavelength bands can be generated, and the imaging module 100 having the color wheel can obtain complete color image information. That is, when one rotation cycle of the color wheel 130 is completed and one rotation cycle of the light-shielding sheet 140 is completed, the image sensor 110 is able to obtain the complete color image information.

In this embodiment, a rotation of the color wheel 130 is a rotation taking an optical axis A1 of the lens group 120 as a rotation axis, and a rotation of the light-shielding sheet 140 is a rotation taking the optical axis A1 of the lens group 120 as the rotation axis.

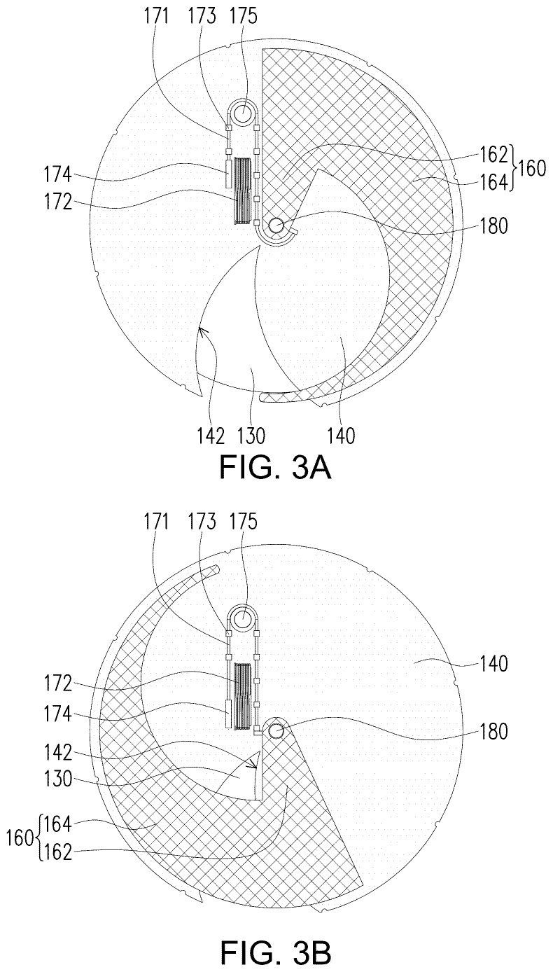

FIG. 3A and FIG. 3B are top schematic views of the light-shielding blade, the light-shielding sheet, the color wheel, the coil, the magnet, and the connecting cord in FIG. 1A in two shielding states of the light-shielding blade. Referring to FIG. 1A, FIG. 1B, FIG. 2A, FIG. 2B, FIG. 3A, and FIG. 3B, the light-shielding blade 160 is connected to the light-shielding sheet 140 and is configured to move relative to the notch 142 so as to cover the notch 142 to different degrees. As shown in FIG. 3A is a state with a smaller covering degree, and as shown in FIG. 3B is a state with a larger covering degree.

In the imaging module 100 having the color wheel in this embodiment, the color wheel 130 disposed above the lens group 120 is adopted. The color wheel 130 includes a plurality of filters 132 of different filtering wavelength bands. The light-shielding sheet 140 disposed above the color wheel 130 is adopted. The light-shielding sheet 140 has a notch 142 to expose a part of the filters 132. By driving at least one of the color wheel 130 and the light-shielding sheet 140 to rotate, images of light of different wavelength bands can be sequentially sensed by the image sensor 110. The images of the light of different wavelength bands can be synthesized into a color image. Therefore, a color image with higher color saturation can be further sensed by the image sensor 110. In addition, in the imaging module 100 having the color wheel in this embodiment, since the color wheel 130 is adopted to sequentially filter out light of different wavelength bands, a structurally simpler image sensor 110 can be used. Thus, a cost of the imaging module can be effectively reduced. Pixels of the image sensor 110 do not need to be divided into sub-pixels of different colors, and colors of the image sensed by the image sensor 110 can be determined by the filters 132 of the color wheel 130 with lower cost, thereby effectively reducing cost. On the other hand, since the pixels of the image sensor 110 do not need to be divided into sub-pixels of different colors, the pixels of the image sensor 110 can be made smaller, or a resolution of the image sensor 110 can be made higher.

In addition, using the filters 132 of different wavelength bands not only improves color accuracy of an image, but also effectively reduces a color cast problem. By precisely controlling spectral characteristics of the filters 132, the technology of the color wheel 130 is able to achieve more realistic color reproduction. In addition, with continuous technological progress, a structure of the color wheel 130 is also continuously optimized to provide a wider color gamut and higher brightness.

Furthermore, in the imaging module 100 having the color wheel in this embodiment, the light-shielding blade 160 connected to the light-shielding sheet 140 is adopted. The light-shielding blade 160 is configured to move relative to the notch 142 so as to cover the notch 142 to different degrees. This way, dual optimization of color and contrast can be achieved. Specifically, when the color wheel 130 and the light-shielding blade 160 (which can be regarded as a variable aperture) jointly act, a synergistic enhancement of color and contrast is achieved. The color wheel 130 is responsible for separating white light into different colors of light such as red, green, and blue to ensure color reproduction and brightness performance of an image. This makes the image have vivid and full colors and be able to faithfully reproduce an original tone of an object. Relying only on the color wheel is not sufficient to meet a demand for high contrast and deep black in certain scenes. At this time, the light-shielding blade 160 (that is, the variable aperture) enhances contrast and color performance of the image by adjusting an amount of light passing through. When necessary, a passage of light is reduced to make a bright area of the scene deeper and the color purer, so that the image becomes more three-dimensional and has more gradation. The combination of this technology retains vividness of color and also enhances detail performance of the image in bright and dark scenes to achieve dual optimization of color and contrast.

This combination has achieved remarkable results on the technical level. A synergistic effect of the color wheel 130 and the light-shielding blade 160 (that is, the variable aperture) is able to provide richer colors and deeper black. The scenes often include images with strong contrast between light and dark, such as night scenes, changes of light and shadow, or action scenes. The scenes place higher demands on color accuracy and contrast. After the color wheel and the light-shielding blade 160 (that is, the variable aperture) are used in combination, original content details can be better reproduced, thereby presenting a realistic image effect.

In addition, the technical combination of the color wheel 130 and the light-shielding blade 160 (that is, the variable aperture) performs excellently when handling dynamic scenes. When brightness in a frame changes frequently, the variable aperture is able to quickly adjust an intensity of light to ensure that the frame is not overexposed due to the change in light. Meanwhile, the color wheel 130 stably provides accurate colors to ensure that the image can still maintain color consistency and accuracy under rapid changes. This design enables the frame to maintain a stable and smooth effect when viewing rapidly moving scenes or frequently switching scenes.

In this embodiment, a boundary B between two adjacent filters of the filters 132 is arc-shaped. In addition, in this embodiment, each filter 132 of the filters 132 has an arc-shaped protruding side C1, an arc-shaped recessed side C2, and an arc side C3 connected to the arc-shaped protruding side C1 and the arc-shaped recessed side C2, wherein a rotation direction D1 of the color wheel 130 is a direction from the arc-shaped recessed side C2 to the arc-shaped protruding side C1. This way, when the color wheel 130 rotates at high speed, airflow can be more effectively guided, and generation of airflow separation and vortex can be reduced, thereby reducing air resistance. This design allows the filters 132 to cut through air more smoothly during rotation and reduce energy loss.

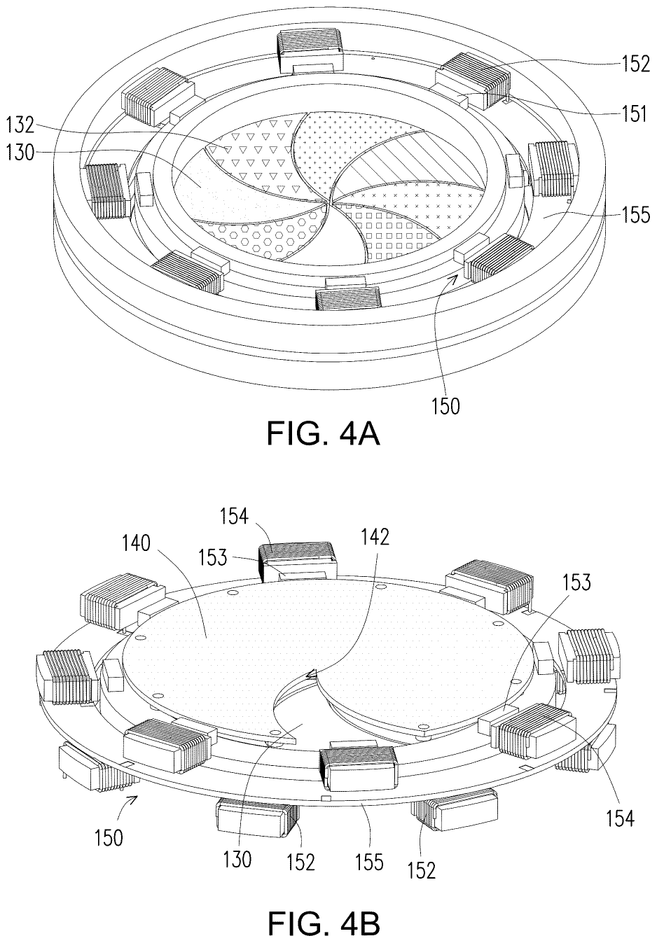

FIG. 4A is a perspective schematic view from an oblique angle of a lower side of a first magnet, a first coil, an annular circuit board, and the color wheel in the imaging module having the color wheel of FIG. 1A, and FIG. 4B is a perspective schematic view from an oblique angle of an upper side of a first coil, an annular circuit board, a second magnet, a second coil, the light-shielding sheet, and the color wheel in the imaging module having the color wheel of FIG. 1A. Referring to FIG. 1A, FIG. 4A, and FIG. 4B, in this embodiment, the driving element 150 includes a plurality of first magnets 151, a plurality of first coils 152, a plurality of second magnets 153, and a plurality of second coils 154. The first magnets 151 are annularly disposed at an edge of the color wheel 130. The first coils 152 correspondingly surround the first magnets 151. In response to the first coils 152 being powered, a first magnetic force is generated. The first magnets 151 are affected by the first magnetic force to drive the color wheel 130 to rotate. That is, the first coils 152 serve as stators, and the first magnets 151 serve as rotors. The second magnets 153 are annularly disposed at an edge of the light-shielding sheet 140. The second coils 154 correspondingly surround the second magnets 153. In response to the second coils 154 being powered, a second magnetic force is generated. The second magnets 153 are affected by the second magnetic force to drive the light-shielding sheet 140 to rotate. That is, the second coils 154 serve as stators, and the second magnets 153 serve as rotors. In this embodiment, the driving element 150 includes an annular circuit board 155, wherein the first coils 152 and the second coils 154 are respectively disposed on two opposite sides of the annular circuit board 155 and are electrically connected to the annular circuit board 155. The annular circuit board 155 is configured to supply current to the first coils 152 and the second coils 154.

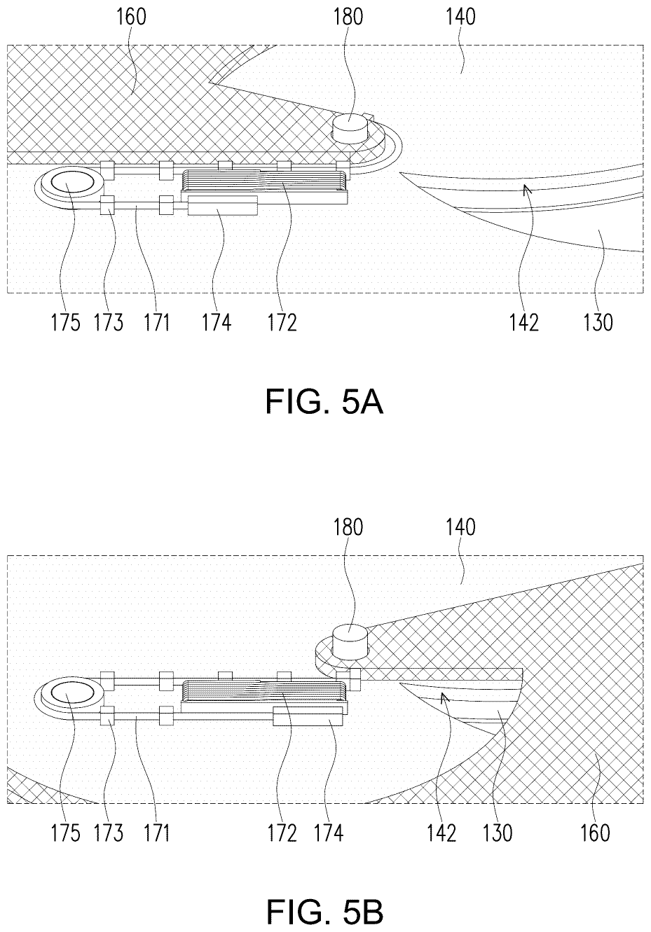

FIG. 5A and FIG. 5B are partial perspective schematic views from an oblique angle of an upper side of the light-shielding blade, the light-shielding sheet, the color wheel, the coil, the magnet, and the connecting cord in FIG. 1A in two shielding states of the light-shielding blade. Referring to FIG. 1A, FIG. 3A, FIG. 3B, FIG. 5A, and FIG. 5B, the imaging module 100 having the color wheel in this embodiment further includes a coil 172, a magnet 174, and a connecting cord 171. The coil 172 is disposed on the light-shielding sheet 140. The magnet 174 is disposed beside the coil 172. The connecting cord 171 connects the magnet 174 and the light-shielding blade 160, wherein a power-on state of the coil 172 is used to change a position of the magnet 174 on the light-shielding sheet 140 (for example, when the coil 172 is powered, a magnetic force is generated on the magnet 174 to change the position of the magnet 174 on the light-shielding sheet 140, so as to drive the light-shielding blade 160 to rotate via the connecting cord 171, thereby changing a covering degree of the light-shielding blade 160 on the notch 142).

In this embodiment, the imaging module 100 having the color wheel further includes a plurality of limiting structures 173 and a roller 175. The limiting structures 173 are disposed on the light-shielding sheet 140, wherein the connecting cord 171 passes through the limiting structures 173. The limiting structures 173 may limit a lateral displacement of the connecting cord and are, for example, limiting rings, and the connecting cord 171 can pass through a hole at a center of the limiting ring. The roller 175 is disposed on the light-shielding sheet 140 and located on a side of the coil 172, wherein the connecting cord 171 bypasses the roller 175 to change an extending direction thereof.

In this embodiment, the light-shielding blade 160 is rotatably connected to the light-shielding sheet 140 via a rotating shaft 180. The light-shielding blade 160 includes a main body portion 162 and a light amount adjusting portion 164. The main body portion 162 is connected to the rotating shaft 180. The light amount adjusting portion 164 is connected to the main body portion 162 and extends along a circumference of the color wheel 130. A width of the light amount adjusting portion 164 in a radial direction of the color wheel 130 gradually decreases from one end connected to the main body portion 162 to an end away from the main body portion 162. This way, with different rotation angles of the light-shielding blade 160, a covering effect of the notch 142 to different degrees can be achieved.

In summary, in the imaging module having the color wheel in the embodiment of the disclosure, the color wheel disposed above the lens group is adopted. The color wheel includes a plurality of filters of different filtering wavelength bands. The light-shielding sheet disposed above the color wheel is adopted. The light-shielding sheet has a notch to expose a part of the filters. By driving at least one of the color wheel and the light-shielding sheet to rotate, images of light of different wavelength bands can be sequentially sensed by the image sensor. The images of the light of different wavelength bands can be synthesized into a color image. Therefore, a color image with higher color saturation can be further sensed by the image sensor. In addition, in the imaging module having the color wheel in the embodiment of the disclosure, since the color wheel is adopted to sequentially filter out light of different wavelength bands, a structurally simpler image sensor can be used. Thus, a cost of the imaging module can be effectively reduced. Furthermore, in the imaging module having the color wheel in the embodiment of the disclosure, the light-shielding blade connected to the light-shielding sheet is adopted. The light-shielding blade is configured to move relative to the notch so as to cover the notch to different degrees, thereby achieving dual optimization of color and contrast.

Finally, it should be noted that the above embodiments are only used to illustrate the technical solutions of the disclosure and are not intended to limit the disclosure. Although the disclosure has been described in detail with reference to the foregoing embodiments, those skilled in the art should understand that modifications may still be made to the technical solutions described in the foregoing embodiments, or some or all of the technical features may be replaced with equivalents. These modifications or replacements do not cause the essence of the corresponding technical solutions to deviate from the scope of the technical solutions in the embodiments of the disclosure.

What is claimed is:

1. An imaging module having a color wheel, the imaging module comprising:
an image sensor;
a lens group, disposed above the image sensor;
a color wheel, disposed above the lens group and comprising a plurality of filters of a different filtering wavelength band;
a light-shielding sheet, disposed above the color wheel and having a notch, wherein the notch exposes a part of the plurality of filters;
a light-shielding blade, connected to the light-shielding sheet and configured to move relative to the notch so as to cover the notch to a different degree; and
a driving element, configured to drive at least one of the color wheel and the light-shielding sheet to rotate.

2. The imaging module having the color wheel according to claim 1, further comprising:
a coil, disposed on the light-shielding sheet;
a magnet, disposed beside the coil; and
a connecting cord, connected to the magnet and the light-shielding blade, wherein a power-on state of the coil is used to change a position of the magnet on the light-shielding sheet so as to drive the light-shielding blade to rotate via the connecting cord, thereby changing a covering degree of the light-shielding blade on the notch.

3. The imaging module having the color wheel according to claim 2, further comprising:
a plurality of limiting structures, disposed on the light-shielding sheet, wherein the connecting cord passes through the plurality of limiting structures; and
a roller, disposed on the light-shielding sheet and located on a side of the coil, wherein the connecting cord bypasses the roller to change an extending direction thereof.

4. The imaging module having the color wheel according to claim 1, wherein the light-shielding blade is rotatably connected to the light-shielding sheet via a rotating shaft, and the light-shielding blade comprises:
a main body portion, connected to the rotating shaft; and
a light amount adjusting portion, connected to the main body portion and extending along a circumference of the color wheel, wherein a width of the light amount adjusting portion in a radial direction of the color wheel gradually decreases from an end connected to the main body portion to an end away from the main body portion.

5. The imaging module having the color wheel according to claim 1, wherein a shape of the notch corresponds to a shape of the filter, and when the driving element drives at least one of the color wheel and the light-shielding sheet to rotate, the notch sequentially exposes the plurality of filters.

6. The imaging module having the color wheel according to claim 1, wherein the driving element comprises:
a plurality of first magnets, annularly disposed at an edge of the color wheel;
a plurality of first coils, correspondingly surrounding the plurality of first magnets, wherein in response to the plurality of first coils being powered, a first magnetic force is generated, and the plurality of first magnets are affected by the first magnetic force to drive the color wheel to rotate;
a plurality of second magnets, annularly disposed at an edge of the light-shielding sheet; and
a plurality of second coils, correspondingly surrounding the plurality of second magnets, wherein in response to the plurality of second coils being powered, a second magnetic force is generated, and the plurality of second magnets are affected by the second magnetic force to drive the light-shielding sheet to rotate.

7. The imaging module having the color wheel according to claim 6, wherein the driving element comprises an annular circuit board, wherein the plurality of first coils and the plurality of second coils are respectively disposed on two opposite sides of the annular circuit board and electrically connected to the annular circuit board.

8. The imaging module having the color wheel according to claim 1, wherein the plurality of filters of the different filtering wavelength band comprise a red filter, a green filter, and a blue filter.

9. The imaging module having the color wheel according to claim 8, wherein the plurality of filters comprise at least one of an infrared transmitting filter and an ultraviolet transmitting filter.

10. The imaging module having the color wheel according to claim 1, wherein the plurality of filters are annularly arranged around an optical axis of the lens group.

11. The imaging module having the color wheel according to claim 10, wherein a boundary between two adjacent filters of the plurality of filters is arc-shaped.

12. The imaging module having the color wheel according to claim 11, wherein each filter of the plurality of filters has an arc-shaped protruding side, an arc-shaped recessed side, and an arc side connected to the arc-shaped protruding side and the arc-shaped recessed side, wherein a rotation direction of the color wheel is a direction from the arc-shaped recessed side to the arc-shaped protruding side.

13. The imaging module having the color wheel according to claim 1, wherein the driving element is configured to drive the color wheel to rotate in a stationary state of the light-shielding sheet, or is configured to drive the light-shielding sheet to rotate in a stationary state of the color wheel.

14. The imaging module having the color wheel according to claim 13, wherein a rotation of the color wheel is a rotation taking an optical axis of the lens group as a rotation axis, and a rotation of the light-shielding sheet is a rotation taking the optical axis of the lens group as the rotation axis.
